(19) United States
(12) Patent Application Publication
(10) Pub. No.: US 2018/0083800 A1
(43) Pub. Date: Mar. 22, 2018

(54) Aggregation Device, System, And Method Thereof

(71) Applicant: Fresco Logic, Inc., Beaverton, OR (US)

(72) Inventor: Robert G. McVay, Portland, OR (US)

(21) Appl. No.: 15/712,432

(22) Filed: Sep. 22, 2017

Related U.S. Application Data
(60) Provisional application No. 62/398,503, filed on Sep. 22, 2016.

(51) Int. Cl. H04L 12/52; G06F 13/42

(52) U.S. Cl. CPC H04L 12/52; G06F 13/4291; H04L 5/26; G06F 2213/0042; G06F 2213/0016

(57) ABSTRACT

An aggregation device includes an aggregation engine circuit and a configuration circuit. The aggregation engine circuit is configured to communicate with multiple protocols and to aggregate data from the protocols into a single channel for transfer, in which the protocols are heterogeneous. The configuration circuit is coupled to the aggregation engine circuit and configured to store one or more settings that define a behavior of the aggregation engine circuit.

### CROSS-REFERENCE TO RELATED APPLICATION

This application claims priority to U.S. Provisional Application Ser. No. 62/398,503, filed Sep. 22, 2016 is herein incorporated by reference.

### BACKGROUND

### Technical Field

The present disclosure relates to an electronic device. More particularly, the present disclosure relates to an aggregator for aggregating data from multiple protocols and a method thereof.

### Description of Related Art

Modern electronic devices or computer systems are implemented with multiple components. These components are employed to communicate to each other for controlling and/or transferring data. Communications among these components may involve a number of different physical channels using a number of different protocols.

In some approaches, the presence of multiple protocols may lead to situations where there is a need to communicate multiple channels using these multiple protocols between two physically separated partitions of the system. As a result, the amount and complexity of connectivity are increased.

### SUMMARY

To address at least the problem discussed above, in some aspects, the disclosure provides an aggregation device which includes an aggregation engine circuit and a configuration circuit. The aggregation engine circuit is configured to communicate with multiple protocols and to aggregate data from the protocols into a single channel for transfer, in which the protocols are heterogeneous. The configuration circuit is coupled to the aggregation engine circuit and configured to store one or more settings that define a behavior of the aggregation engine circuit.

In some aspects, the disclosure provides a system which includes a first aggregation device and a second aggregation device. The first aggregation device includes a first aggregation engine circuit. The first aggregation engine circuit is configured to communicate with a first plurality of protocols and to aggregate first data from the first plurality of protocols into a first aggregation channel, in which the first plurality of protocols are heterogeneous. The second aggregation device includes a second aggregation engine circuit. The second aggregation engine circuit is configured to communicate with a second plurality of protocols and to aggregate second data from the second plurality of protocols into a second aggregation channel, in which the first aggregation channel is coupled to the second aggregation channel via a physical channel in order to transfer the first data and the second data between the first aggregation device and the second aggregation device, and the second plurality of protocols are heterogeneous.

In some aspects, the disclosure provides a aggregation method which includes the following operations: communicating, by an aggregation engine circuit, with a plurality of protocols, and to aggregate data from the plurality of protocols into a single channel for transfer, wherein the plurality of protocols are heterogeneous; and configuring, by a configuration circuit, a behavior of the aggregation engine circuit.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an aggregation device, according to some embodiments of the present disclosure.

FIG. 2 is a schematic diagram of a system, according to some embodiments of the present disclosure.

FIG. 3 is a flow chart of an aggregation method, according to some embodiments of the present disclosure

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In this document, the term “coupled” may also be termed as “electrically coupled”, and the term “connected” may be termed as “electrically connected”. This is for ease of understanding and not intended to preclude implementations where this connection may alternatively be optical (e.g. fiber or visible light), electromagnetic (e.g. wireless), or mechanical (e.g. acoustic) in nature. “Coupled” and “connected” may also be used to indicate that two or more elements cooperate or interact with each other.

It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In some aspects, the present disclosure provides a novel aggregator and a novel method for aggregating multiple heterogeneous communication channels and/or protocols in to a single channel for transmission.

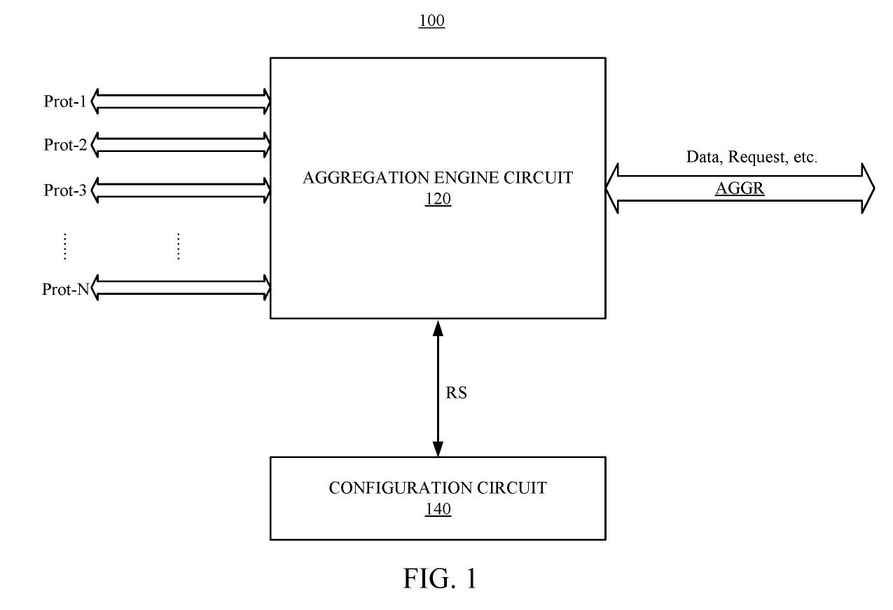

Reference is now made to FIG. 1. FIG. 1 is a schematic diagram of an aggregation device 100, according to some embodiments of the present disclosure. In various embodiments, the aggregation device 100 is configured to aggregate data transmitted from multiple protocols Prot1-ProtN into a single channel for transfer.

As illustratively shown in FIG. 1, the aggregation device 100 includes an aggregation engine circuit 120 and a configuration circuit 140.

In some embodiments, the aggregation engine circuit 120 is coupled to one or more communication interfaces, pins, or ports which correspond to the protocols Prot1-ProtN, in order to receive data from or transmit data to the one or more electronic devices. In some embodiments, the aggregation engine circuit 120 is configured to aggregate the data or requests from the protocols Prot1-ProtN into a single aggregation channel AGGR. Effectively, the protocols Prot1-ProtN are able to communicate with other devices (not shown) transparently via the single aggregation channel AGGR.

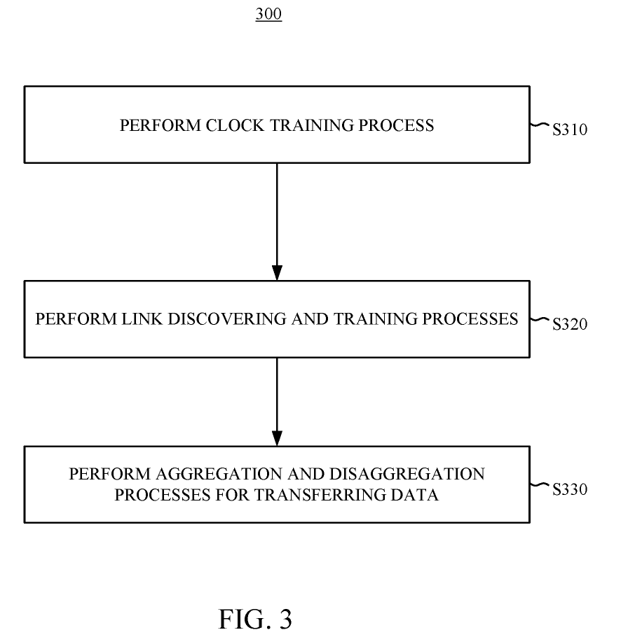

In some embodiments, the aggregation engine circuit 120 is implemented with an arbiter. In some embodiments, the aggregation engine circuit 120 is configured to step through each client (i.e., protocols Prot1-ProtN) that requests for transmitting on one side and simultaneously each client that requests for receiving on the other side (not shown in FIG. 1). In a non-limiting example, each protocol Prot1-ProtN waits for the grant and transmits/receives data until complete. Each protocol Prot1-ProtN is configured to send and claim a correct number of bits of data. Details of the aggregation are described with reference to operation S310 in FIG. 3 below.

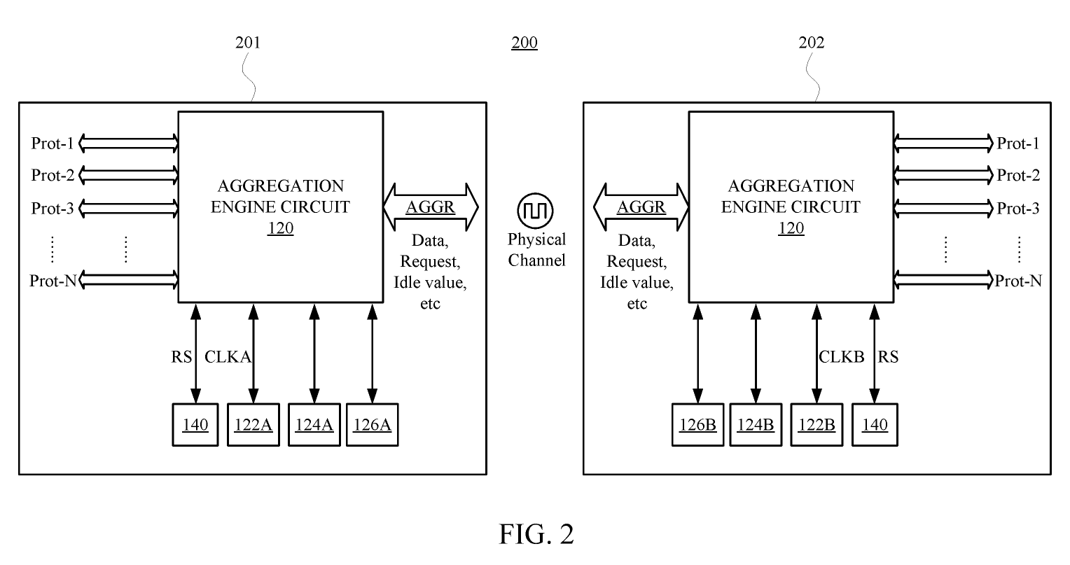

In some embodiments, the single channel AGGR is implemented as a proprietary protocol or standard protocol. In some embodiments, the channel AGGR is configured to communicate with one or more physical mediums (e.g., physical channel shown in FIG. 2 below), and/or to operate with one or more physical layers. In some embodiments, the physical mediums may include a half-duplex or a full-duplex channel. In some embodiments, the physical mediums may be wired or wireless channels. In some embodiments, the physical layers may include USB or SuperSpeed USB. The types of the physical mediums and the physical layers are given for illustrative purposes. Various types of the physical mediums and the physical layers are within the contemplated scope of the present disclosure.

In some embodiments, these different protocols Prot1-ProtN are heterogeneous. In some embodiments, the protocols Prot1-ProtN may include universal serial bus (USB), inter-integrated Circuit (I2C) bus, serial bus, integrated interchip sound (I2S), serial peripheral interface (SPI), System Management Bus (SMBus), Sony/Philips digital interface format (SPDIF), power delivery (PD), Display Port, high definition multimedia interface (HDMI), and/or general purpose inputs/outputs (GPIO). The types of the protocols Prot1-ProtN are given for illustrative purposes. Various types of the protocols Prot1-ProtN are within the contemplated scope of the present disclosure.

In some embodiments, one or more communication interfaces are integrated and operated with the aggregation engine circuit 120. The one or more communications are configured to request for data to be transmitted from the protocols Prot1-ProtN, or to access to internal device properties. For example, an I2C interface and a GPIO interface are employed for controlling a PD power supply. Alternatively, a SPI interface is employed for external control of PD. The types and the functions of the interfaces are given for illustrative purposes. Various types and the functions of the interfaces are within the contemplated scope of the present disclosure.

In some embodiments, the configuration circuit 140 is configured to store settings associated with a behavior of the aggregation engine circuit 120 and the protocols Prot1-ProtN. In some embodiments, the configuration circuit 140 is implemented with registers. The registers are configured to store one or more register values RS indicating the settings of the aggregation engine circuit 120. In some embodiments, these registers can be used to specify properties of the physical channel interconnect (latency, half or full-duplex, external transceiver present), clocking (asynchronous, pseudo-synchronous, source synchronous), link level properties (length of preamble, inter-packet gap, idle value) and other on-chip configurations, as well as the numbers and types of protocols that will be aggregated.

For example, the registers can be used to specify that certain pins are implemented as open drain I/O (for use as an I2C bus) whereas certain other pins are treated as a high-bandwidth input from the aggregation device 201 to the aggregation device 202 and yet another pair of inputs are handled as low jitter inputs from the aggregation device 202 to the aggregation device 201 and a final set of pins are used to carry the DisplayPort AUX channel and Hot Plug Detect signals. In this way, the entire collection of protocols (Prot1-ProtN) can be defined as to how (or if) they will be aggregated on the aggregation channel AGGR. In some embodiments, this configuration information is communicated from one aggregation device to the other during an initialization and link training process.

Reference is now made to FIG. 2. FIG. 2 is a schematic diagram of a system 200, according to some embodiments of the present disclosure. For ease of understanding, like elements in FIG. 2 are designated with the same reference number with respect to FIG. 1.

As illustratively shown in FIG. 2, the system 200 includes an aggregation device 201 and an aggregation device 202. The arrangements of each of the aggregation device 201 and the aggregation device 202 are similar with the aggregation device 100 in FIG. 1. Accordingly, the repetitious descriptions are not given herein.

In some embodiments, the aggregation engine circuits 120 of the aggregation devices 201 and 202 are coupled with each other via at least one physical channel, in order to transfer data therebetween. In greater detail, the aggregation channel AGGR of the aggregation device 201 is coupled to the aggregation channel AGGR of the aggregation device 202 via the at least one physical channel. In some embodiments, at least one physical channel is implemented with a physical transport medium. The physical transport medium may include pogo pin, FR4 substrate, radio frequency (RF) transceiver, light-emitting diode (LED), laser, etc. With this arrangement, protocol bundles (i.e., protocols Prot1-ProtN) are able to be reproduced transparently on each side of the aggregation channel AGGR.

The types of the physical transport medium are given for illustrative purposes. Various types of the physical transport medium to implement at least one physical channel are within the contemplated scope of the present disclosure.

In some embodiments, the aggregation engine circuits 120 of the aggregation devices 201 and 202 are configured to operate with a master/slave configuration. For example, the aggregation engine circuit 120 of the aggregation device 201 is configured to act in the role of master, and the aggregation engine circuit 120 of the aggregation device 202 is configured to act in the role of slave. In some embodiments, when acting in the role of master, the aggregation engine circuit 120 may send data on the link without regard to link state. In some embodiments, when acting in the role of slave, the aggregation engine circuit 120 only transmits data on the aggregation link in response to certain data (requests) received from the master device on the aggregation channel AGGR. With this configuration, bus contention on the channel is avoided in the case that a half-duplex medium is employed, and the aggregation engine circuit 120, which acts in the role of master, can transmit data at any time.

In some embodiments, the aggregation devices 201 and 202 are devices that cooperate with each other. For example, the aggregation device 201 is a tablet which acts in the role of master. The aggregation device 202 is a smart base which acts in the role of slave and is able to support and to be coupled with the tablet. In some embodiments, the tablet may include smartphone, laptop, etc. In some embodiments, the smart base may include dongle, adapter, dock, or any suitable accessory. The implementations of the tablet and the smart base are given for illustrative purposes. Various kinds of tablet and various kinds of the smart base are within the contemplated scope of the present disclosure.

Reference is now made to both of FIG. 2 and FIG. 3. FIG. 3 is a flow chart of an aggregation method 300, according to the some embodiments of the present disclosure. As an example, the operations of the aggregation method 300 are described with the operations of the system 200 in FIG. 2. Furthermore, to facilitate the descriptions of operations of the method 300, in the following paragraphs, the aggregation device 201 in FIG. 2 is considered to act in the role of master and is thus referred to as “master device 201” hereinafter. The aggregation device 202 in FIG. 2 is considered to act in the role of slave and is thus referred to as “slave device 202” hereinafter.

In some embodiments, the aggregation method 300 includes operations S310, S320, and S330.

In operation S310, a clock training process is performed. The purpose of the clock training process is to convey, from the master device 201 to the slave device 202, information needed for setting up bi-directional aggregation of data between the devices 201 and 202. In order to provide the most efficient connectivity for support of different protocols, different clocking modes are able to be applied in the system 200 in FIG. 2. In various embodiments, the clocking modes include a synchronous mode, an asynchronous mode, and a pseudo-synchronous mode.

The following paragraphs are related to the synchronous mode and operation S310. Referring to FIG. 2, in the synchronous mode, the aggregation engine circuits 120 and related logic circuits (not shown) of the devices 201 and 202 are operating on the same logical clock. In other words, the clocks on the devices 201 and 202 are configured to be common in the synchronous mode. In some embodiments, in the synchronous mode, a common clock signal is transmitted via the aggregation channel AGGR to linking protocols Prot1-ProtN.

For example, the device 201 further includes a local clock generator 122A, and the device 202 further includes a local clock generator 122B. The local clock generator 122A is configured to generate a local reference clock signal CLKA, in order to in order to synchronize or control different parts (e.g., the circuits 120 and 140) of the device 201. Similarly, the local clock generator 122B is configured to generate a local reference clock signal CLKB, in order to in order to synchronize or control different parts (e.g., the circuits 120 and 140) of the device 202.

In some embodiments, in operation S310, the local clock generator 122A is configured to transmit the local reference clock signal CLKA to the slave device 202 via the aggregation channel AGGR. The slave device 202 is further configured to measure the received local reference clock signal CLKA and to tune the local clock generator 122B based on a difference between the local reference clock signals CLKA and CLKB, in order to match the frequencies of the local reference clock signals CLKA and CLKB.

In some embodiments, the operation of comparing and tuning discussed above may be performed by the aggregation engine circuit 120 of the slave device 202 or by a processing unit of the slave device 202. Various units or circuits in the slave device 202 to perform the operation of comparing and tuning are within the contemplated scope of the present disclosure.

In some embodiments, the master device 201 continues to send the local reference clock signal CLKA for a predetermined time, in order to allow the slave device 202 have to enough time to match the frequency. At the completion of the clock training process, the master device 201 queries the slave device 202 by sending data over the aggregation channel AGGR, in order to determine to what level the clock training of operation S310 was successful. Based on response from the slave device 202, one or more operating modes that can be utilized by the link are able to be indicated.

The following paragraphs are related to the asynchronous mode and operation S310. In certain conditions, the master device 201 and the slave device 202 are configured to run with independent frequencies of local reference clock signals CLKA and CLKB. Under these conditions, the asynchronous mode is employed.

In some embodiments, the devices 201 and 202 are further configured to perform clock and data recovery (CDR) operations, in order to recover data bits from the aggregation channel AGGR and to search a start of the data bits. In some embodiments, the start of the data bits is determined by pattern matching. For example, the master device 201 or the slave device 202 sends a preamble pattern at the start of each transmission, in order to identify the start of the data bits. In some embodiments, a data length, a polarity, and a matching requirement of the preamble pattern are programmable. In some embodiments, the preamble pattern is also used in the recovery of the data bits. If the preamble pattern is matched, data transmitted to the aggregation engine circuits 120 is normal.

In some embodiments, the device 201 further includes a CDR circuit 124A, and the device 202 further includes a CDR circuit 124B. The CDR circuits 124A and 124B are configured to perform the CDR operations discussed above. In some other embodiments, the CDR circuit 124A may be integrated in the aggregation engine circuit 120 of the device 201, and the CDR circuit 124B may be integrated in the aggregation engine circuit 120 of the device 202. In other words, in these embodiments, the CDR operations may be performed by the aggregation engine circuits 120 of the devices 201 and 202. Various units or circuits to perform the CDR operations are within the contemplated scope of the present disclosure.

The following paragraphs are related to the pseudo-synchronous mode and operation S310. In the pseudo-synchronous mode, the slave device 202 is configured to constantly adjust the frequency of the local clock reference signal CLKB, in order to match the frequency of the local clock reference signal CLKA of the master device 201. The operations of the pseudo-synchronous mode may be performed by the local clock generators 122A and 122B with the CDR circuits 124A and 124B, but the present disclosure is not limited thereto. In some embodiments, when operating in the pseudo-synchronous mode, clock compensation events are allowed.

With continued to reference to FIG. 3, in operation S320, link discovering and training processes are performed. In some embodiments, a resistive termination scheme in employed in the system 200 in FIG. 2, in order to perform the link discovering process. For example, when in an idle condition, the master device 201 receives data indicating an idle value of logic “1” on the aggregation channel AGGR. Accordingly, whenever a connection to the aggregation channel AGGR is made by the slave device 202, the idle value received by the master device 201 goes from logic “1” to logic “0.” Effectively, the master device 201 is able to discover an attachment to a slave device 202 based on the idle value.

With this arrangement, in some embodiments, the master device 201 may further include a low-power circuit 126A. The low-power circuit 126A is configured to monitor the aggregation channel AGGR, in order to wake up (enable) the aggregation engine circuit 120 if the idle value transits from logic “1” to logic “0.” In some embodiments, the slave device 202 may further include a low-power circuit 126B. The low-power circuit 126B is configured to monitor the aggregation channel AGGR, in order to detect any activity.

In some embodiments, the resistive termination scheme is implemented with a pull-up circuit and a pull-down circuit. The pull-up circuit is employed to pull up voltage levels of transmission interfaces/pins/port, corresponding to the protocols Prot1-ProtN, at the master device 201 to a high voltage, in order to generate the idle value of logic “1.” Alternatively, the pull-down circuit is employed to pull down voltage levels of transmission interfaces/pins/port, corresponding to the protocols Prot1-ProtN, at the slave device 202 down to a low voltage, in order to generate the idle value of logic “0.” The implementations of the resistive termination scheme are given for illustrative purposes. Various implementations of the resistive termination scheme are within the contemplated scope of the present disclosure.

In some embodiments, the training process in operation S310 is performed by using a the channel in “training mode”, which is expected to be a lowest common denominator channel, with robustness taking precedence over performance. In some embodiments, the technique of preamble pattern matching, which is similar with operations discussed in the asynchronous mode, is employed in the training process such that the training channel is able to reliably communicate over a worst-case physical channel.

In a non-limiting example, the training process includes transferring a set of register values (e.g., RS) from the master device 201 to the slave device 202. In some embodiments, the set of register values are associated with control parameters of the link, which include, for example, sizes of pre-amble pattern, post-amble pattern, inter-packet gap (IPG), idle value, etc. In some embodiments, the set of register values may be stored in registers of the configuration circuit 140. In some embodiments, the set of register values are copied from the master device 201 to the slave device 202.

For example, if the number of the register values is assumed to be 32. To verify correct training, each register (number 0-31) is transferred as below. The master device 201 sequentially transmits a first byte that indicates training index (0-31), a second byte that indicates training values (0-255), and a third byte that indicates training CRC covering the first and the second bytes. If the slave device 202 correctly receives these bytes transmitted from the master device 201 (which indicates CRC matches), the slave device 202 then writes the training values into the registers corresponding to the training index.

Afterwards, the slave device 202 reads back the registers and sequentially transmits a first byte that indicates training index received from the master device 201, a second byte that indicates training read back values, and a third byte that indicated training CRC covering the first and the second bytes. If the master device 201 correctly receives these 3 bytes (which indicates CRC matches), the master device 201 advances to the next training index and repeats the same process until the final training index is transmitted and echoed back successfully. Finally, the master device 201 transmits an index that indicates end of the training to the slave device 202 such that the training process is complete.

If the slave device 202 detects a CRC error in the training process, the slave device 202 rejects the new training index and responds with the same training index of the previous correctly received sequence. If the master device 201 detects a CRC error in the training process, the master device 201 stops sending the next training index and re-transmits the previous training sequence. If the training process is complete, the link is enabled for aggregation.

With continued reference to FIG. 3, in operation S330, aggregation and disaggregation processes for transferring data between the master device 201 and the slave device 202 are performed. In the aggregation/disaggregation processes, a technique of Time-division multiplexing (TDM) is employed.

In a non-limiting example, the protocols Prot1-ProtN transmit data to or receive data from the aggregation engine circuit 120 at different time slots (e.g., different duty cycles). The term “duty cycle” is defined as the time used to send or to receive the data.

As noted above, the aggregation engine circuit 120 includes one or more communication interfaces that are able to request for data to be transmitted at any time. The aggregation engine circuit 120 is configured to select a client among the protocols Prot1-ProtN that asserting requests when entering one duty cycle. Accordingly, the selected client is determined to correspond to the duty cycle. The aggregation engine circuit 120 then accepts the data transmitted from the selected client and transmit the same at the duty cycle. Effectively, one client is granted to transmit data for one duty cycle.

In some embodiments, if more than one bit of data are required to transmit, the selected client continues to assert its request until the last bit has been presented. Once the selected client has transmitted all bits of the data, the aggregation engine circuit 120 further selects a next client from among the protocols Prot1-ProtN, in order to perform the similar operations discussed above. The aggregation engine circuit 120 repeats this process until each requested client has transmitted all of the data. Effectively, with operations discussed above, data from the protocols Prot1-ProtN are aggregated onto the aggregation channel AGGR.

As for the disaggregation process, operations of the disaggregation process are symmetrical to the operations of the aggregation process. In a non-limiting example, the aggregation engine circuit 120 of the receiver device selects a client among the protocols Prot1-ProtN on its side when entering a duty cycle. Accordingly, the selected client is determined to correspond to the duty cycle. If the selected client requests to receive more bits of data, the selected client continue to assert its request until the last bit of data has been received. Once the selected client has received all bits of the data, the aggregation engine circuit 120 further selects a next client from among the protocols Prot1-ProtN, in order to perform the similar operations discussed above. The aggregation engine circuit 120 repeats this process until each requested client has received all of the data. Effectively, with operations discussed above, data over the aggregation channel AGGR are dis-aggregated and received by clients.

The above description of the method 300 includes exemplary operations. The order of the operations of the method 300 may be changed, or the operations may be executed simultaneously or partially simultaneously as appropriate, in accordance with the spirit and scope of various embodiments of the present disclosure.

In some embodiments, the aggregation engine circuit 120 may be configured to cooperate with certain functions and/or circuits of physical layer interfaces, in order to perform operations discussed above. For illustration, in a case that the GPIO protocols are employed in the protocols Prot1-ProtN, an acquire function and a driving function of the GPIO protocols may be utilized. The acquire function is for sampling input, and the driving function is for driving signals to corresponding link partner. With respect to GPIO, any protocol can be aggregated if the protocol can be made compatible to the physical interconnect of the particular realization of aggregation devices, can be mapped to a collection of unidirectional wires or bidirectional wires with a direction signal, and can tolerate the latency and jitter of the particular realization of the aggregation channel. Furthermore, with respect to GPIO, one or more unique settings, including programmable bandwidth settings, jitter mode, and clock (or periodic) mode, may be employed.

For programmable bandwidth settings, in normal mode of GPIO, each input is sampled once per ring period (e.g., duty cycle discussed above), and the sampled input is sent to the link partner and is then placed on the output of the link partner. Effectively, in the normal mode, the sampling rate is equal to the ring frequency. In order to support higher bandwidths, the sampling rate can be increased. For example, the input is sampled multiple times in each ring period, and thus the sampled inputs are sent to the link partner at a rate that is a fraction of the ring period. Alternatively, in order to support the low bandwidth signals, the input may be sampled at a rate of every N ring periods, in which N is greater than 1 (e.g., 4). With the bandwidth settings discussed above, the sampling rate of each GPIO is optimized to adapt the desired transfer rates while minimizing the ring size.

For jitter mode, timing information is transmitted along with the data value. For example, if the input is sampled every clock cycle and the input changes from a logic value of 0 at cycle 11, to a logic value of 1 at cycle 12, respectively. In the next transmission, instead of transmitting the data, the information about a transition is present and the fact that the 0-to-1 transition occurred at cycle 12 is transmitted. The link partner will then drive that 0-to-1transition to the output during cycle 12 of the following ring. If no transition during a give ring (e.g., 16 cycles) is detected, then a flag indicating “no transition” is sent. The remaining bit(s) that would normally carry information of edge location (i.e., transitions of the signal) can be utilized to transmit current values of the signal. With such the arrangement, each edge from near side to far side is able to be reproduced with a precision of one cycle. Even lower jitter is possible by sampling and reproducing edges with sub-cycle accuracy.

As for clock (or periodic) mode, high frequency signals are allowed to be reproduced. In order to aggregate periodic signals with high frequency, a periodic wave generator may be employed on each side of the channel. This periodic wave generator is configured to be programmed to create a signal having a waveform with an arbitrary frequency and duty cycle. In some embodiments, if these signals are not used for aggregation, these signals may be used to provide local clock resources.

The mechanism for aggregating a periodic signal from input to output is explained herein. First of all, the GPIO is placed into “clock” mode. The device at input side goes into acquisition mode while the device at the output side goes into a wait mode in order to receive instructions from the link partner. During acquisition, the input signal is sampled continuously looking for edges, in which the rising edges carry frequency information and the falling edges carry information that may be used to set the duty cycle. During the acquisition phase, the goal is to come up with starting values for the HIGH and LOW periods for the periodic wave generator One simple implementation of the acquisition phase is to run counters on the internal clock and on this periodic signal. After running these counters for a predetermined time, a ratio of the relative frequencies of the two clocks can be obtained, and the ratio is also a ratio for programming the periodic clock generator. In order to set the initial duty cycle, different approaches may be employed based on the relative frequencies of the input signal and the aggregation engine circuit 120. If the input signal is relatively slow, the number of low cycles and the number of high cycles may be directly used. For higher frequency inputs, a sub-cycle sampling approach, which is similar to the logic used in the jitter mode, may be employed. In some applications, at very high frequencies, the duty cycle is less important and may be configured to have a user-selectable duty cycle (e.g., 50%).

Upon completion of the acquisition phase, the initialization phase is entered. After acquisition, values for both the HIGH and LOW settings for the wave generators are determined. The device at the input side communicates these values over the aggregation channel AGGR to the device at the output side, and both sides program the respective wave generators. The communication incorporates a handshake such that both sides will enable the wave generators at the same time. The device at the input side is responsible for controlling the enabling of both wave generators so that the devices are phase aligned with the input. At this point, the wave generators in both sides have been programmed with the correct waveforms and the periodic signal at the input is being reproduced on the output side. Technically, the signal has not been aggregated across the channel, only the information needed to reproduce it has. With the clock mode, periodic signals that have a frequency higher than the aggregation channel AGGR are allowed to be aggregated.

In an another non-limiting example where the Display port (DP) Aux Channel and Hot-Plug Detect (HPD) protocols are employed in the protocols Prot1-ProtN, a data sampler and a data buffer of the DP Aux protocols may be utilized. The data sampler is for capturing each unit interval on an AUX channel of the DP protocols as 1-bit of data for aggregation. The data buffer has a capacity of storing a number of bits (e.g., 160 bits) of data, and is for storing data sampled by the data sampler. The data buffer is also for monitoring the data content to detect number of pre-charges and preambles. Each HPD event is similarly captured as a set of events on the receiving side and transmitted over the AGGR channel and reproduced on the driving side.

In a further non-limiting example where the Full and/or Low-Speed USB protocols are employed in the protocols Prot1-ProtN, a re-timer of the USB protocol is employed. The re-timer transparently passes data from/to the upstream (host) to/from the downstream (device) with only a small delay through the aggregation process, allowing the devices to maintain communication during the aggregation with no impact to system software or USB hierarchy.

The above examples are given for illustrative purposes only. It is understood that, based on embodiments above, person skilled in the art is able to utilize, adjust, or modify functions and/or circuits of present physical layer interfaces, without departing from the scope or spirit of the disclosure, in order to cooperate with the aggregation engine circuit 120 for the purpose of data aggregation. Thus, various functions and/or circuits of physical layer interfaces able to cooperate with the aggregation engine circuit 120 are within the contemplated scope of the present disclosure.

As discussed above, the aggregation device 100, the system 200, and the aggregation method 300 provided in the present disclosure are able to aggregate data from multiple protocols. As a result, the amount and complexity of connectivity are able to be decreased.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An aggregation device, comprising:
an aggregation engine circuit configured to communicate with a plurality of protocols and to aggregate data from the plurality of protocols into a single channel for transfer, wherein the plurality of protocols are heterogeneous; and
a configuration circuit coupled to the aggregation engine circuit, the configuration circuit configured to store one or more settings that define a behavior of the aggregation engine circuit.

2. The aggregation device of claim 1, wherein the plurality of protocols comprise at least one of universal serial bus (USB), inter-integrated Circuit (I2C) bus, serial bus, integrated interchip sound (I2S), serial peripheral interface (SPI), System Management Bus (SMBus), Sony/Philips digital interface format (SPDIF), power delivery (PD), Display Port, high definition multimedia interface (HDMI), and general purpose inputs/outputs (GPIO).

3. The aggregation device of claim 1, wherein the single channel of the aggregation engine circuit is further coupled to an electronic device via at least one physical channel for transferring aggregated data.

4. The aggregation device of claim 3, wherein the at least one physical channel comprise at least one of a pogo pin, an FR4 substrate, a radio frequency transceiver, a light-emitting diode, and a laser.

5. The aggregation device of claim 1, wherein the aggregation engine circuit is further configured to operate with the plurality of protocols in a pseudo-synchronous mode.

6. A system, comprising:
a first aggregation device comprising:
a first aggregation engine circuit configured to communicate with a first plurality of protocols and to aggregate first data from the first plurality of protocols into a first aggregation channel, wherein the first plurality of protocols are heterogeneous; and
a second aggregation device comprising:
a second aggregation engine circuit configured to communicate with a second plurality of protocols and to aggregate second data from the second plurality of protocols into a second aggregation channel,
wherein the first aggregation channel is coupled to the second aggregation channel via a physical channel in order to transfer the first data and the second data between the first aggregation device and the second aggregation device, and the second plurality of protocols are heterogeneous.

7. The system of claim 6, wherein the first aggregation device and the second aggregation device are configured to operate with a master/slave configuration.

8. The system of claim 6, wherein the first aggregation device is further configured to perform a clock training process with the second aggregation device, in order to set up one or more clocking modes for providing connectivity between the first aggregation device and the second aggregation device.

9. The system of claim 8, wherein the one or more clocking modes comprises a synchronous mode, an asynchronous mode, and a pseudo-synchronous mode.

10. The system of claim 6, wherein the first aggregation device is further configured to perform a link discovering process with the second aggregation device, in order to detect whether a link from the second plurality of protocols coupled to the second aggregation device is created.

11. The system of claim 10, wherein the first aggregation device is further configured to perform a link training process with the second aggregation device, by processing one or more register values associated with the link, in order to enable the link for aggregation.

12. The system of claim 6, wherein the first aggregation device is further configured to transfer the first data and the second data with the second aggregation device in a manner of time-division multiplexing.

13. The system of claim 6, wherein each of the first plurality of protocols and the second plurality of protocols comprise at least one of universal serial bus (USB), inter-integrated Circuit (I2C) bus, serial bus, integrated interchip sound (I2S), serial peripheral interface (SPI), System Management Bus (SMBus), Sony/Philips digital interface format (SPDIF), power delivery (PD), Display Port, high definition multimedia interface (HDMI), and general purpose inputs/outputs (GPIO).

14. The system of claim 6, wherein the physical channel comprises at least one of a pogo pin, an FR4 substrate, a radio frequency transceiver, a light-emitting diode, and a laser.

15. The system of claim 6, wherein the first aggregation device further comprises:
a configuration circuit coupled to the first aggregation engine circuit, the configuration circuit configured to store one or more settings that define a behavior of the first aggregation engine circuit.

16. The system of claim 6, wherein the second aggregation device further comprises:
a configuration circuit coupled to the first aggregation engine circuit, the configuration circuit configured to store one or more settings that define a behavior of the first aggregation engine circuit.

17. An aggregation method, comprising:
communicating, by an aggregation engine circuit, with a plurality of protocols and to aggregate data from the plurality of protocols into a single channel for transfer, wherein the plurality of protocols are heterogeneous; and
configuring, by a configuration circuit, a behavior of the aggregation engine circuit.

18. The aggregation method of claim 17, wherein communicating with a plurality of protocols comprises:
performing a clock training process, in order to set up one or more clocking modes for providing connectivity between the single channel and the plurality of protocols.

19. The aggregation method of claim 17, wherein communicating with a plurality of protocols comprises:
performing a link discovering process, in order to detect whether a link from the plurality of protocols is created; and
performing a link training process by processing one or more register values associated with the link, in order to enable the link for aggregation,
wherein the one or more register values are stored in the configuration circuit.

20. The aggregation method of claim 17, wherein the data are transmitted over the single channel in a manner of time-division multiplexing.
